(19) United States
(12) Patent Application Publication
(10) Pub. No.: US 2015/0264872 A1
(43) Pub. Date: Sep. 24, 2015

(54) Plant Protector

(71) Applicants: Peter Grant Jordan, Stittsville (CA); Harley Lane, Stittsville (CA)

(72) Inventors: Peter Grant Jordan, Stittsville (CA); Harley Lane, Stittsville (CA)

(21) Appl. No.: 14/219,361

(22) Filed: Mar. 19, 2014

(51) Int. Cl. A01G 13/10; A01M 99/00; A01M 25/00; A01G 25/00; A01M 1/20

(52) U.S. Cl. CPC A01G 13/105; A01G 25/00; A01M 1/20; A01M 25/00; A01M 99/00

(57) ABSTRACT

An apparatus for protecting sprouting seeds, seedlings and plants, hereinafter referred to as “plant material”, from damage by crawling insects, antrhopoda, and gastropoda, hereinafter referred to as “crawling pests”, and various beetles, moths and butterflies, hereinafter referred to as “flying pests”, and for enhancing the rate of growth which comprises a formed smooth plastic or metal frame the lower portion of which is inserted into the ground, the upper edge of which extends outwards and then downwards wherein this formed edge creates a barrier for crawling pests, the inside of which is a reflective colour wherein sunlight reflected from the interior surfaces enhances the early stage growth of plants contained within, the top of which can be covered with a removable frame with integrated insect cloth wherein such cloth prevents access to flying pests, the top of which can be covered with a removal frame with integrated transparent material to help create a warmer and more humid microclimate to counteract unfavorable weather, the inside of which can be fitted with a micro-watering system wherein this system conserves water and prevents plant foliage from being excessively wetted thus reducing susceptibility to certain diseases such as powdery mildew.

### FIELD OF THE INVENTION

The present invention relates to an apparatus for the protection of plant material from crawling and flying pests and for enhancing the growing environment for plant material.

### BACKGROUND OF THE INVENTION

Countries continue to implement progressive laws limiting the use of harmful chemical pesticides for home use. Gardeners are experiencing a resurgence of crawling pests that cause extensive damage to plant material especially in early stages of growth when plants are started from seeds directly in the garden soil. While not a complete list, these pests include those that usually crawl over the surface of the soil such as pill bugs, sow bugs, earwigs, snails and slugs. These pests appear to be opportunistic. That is, if they encounter material meeting their dietary requirements, they inflict damage. Such damage is most severe when seeds are forming the first true leaves after the cotyledon emerges. Such damage at this stage of growth is often fatal for the plant or severely stunts or retards the plant's future growth.

In addition to crawling pests referred to in the previous paragraph, there are flying pests. To prevent access to plant material by flying pests, a removable insect cover consisting of a frame covered with insect screening material is placed over the top frame of the apparatus until the plant material is more fully developed.

Regular irrigation in the absence of sufficient natural rainfall is necessary to encourage healthy plant growth. But, certain plant diseases are exacerbated by wet foliage that results from overhead watering systems. To reduce wetting of foliage and to promote eco-friendly water usage, a micro watering facility can be inserted inside the frame of the apparatus. Irrigating in this matter applies water where it is needed and the walls of the apparatus prevent runoff thus conserving this resource.

In the early part of the plant's growth cycle from seed, heat and sunlight are the engines of growth. The walls of the apparatus reduce the soil drying and cooling effect of wind shear across the soil surface and reflect light back on the plant material. This provides a more favorable growing environment. For cooler weather or when frost is possible, a removable transparent cover consisting of a frame covered with transparent material can be installed on the top of the apparatus to retain heat and help protect the plant material.

The apparatus can remain in place for the entire plant growing cycle or it can be removed and reused when the plants are hardy enough to withstand minor pest damage. When plant material growth extends to the top frame of the apparatus, the removable insect cover and removable transparent cover are simply uninstalled allowing the plant material to grow on.

### SUMMARY

The invention is directed generally to an apparatus for protecting and enhancing the growth of plant material.

The invention comprises a box open on the top and bottom made of rigid material such as metal or plastic which material is not subject to rapid damage by water or wet soil. The box which is typically rectangular is constructed of four vertical walls. The top of the vertical walls protrudes outwards and then downwards to form an inverted channel. The channel is continuous around the entire top wall with no gaps at the corners. The bottom walls have a slight outwards flare on the bottom edge. This flared edge has holes through which spikes can be inserted to secure the apparatus in place. A removable frame is covered with insect screening material, hereinafter referred to as “insect cover”. A second removable frame is covered with a transparent material, hereinafter referred to as “transparent cover”. One cover may be installed at a time. The covers are held in place by small channels formed on the top of the end walls. This channel just accommodates the thickness of the removable frame thus holding it securely in place. The width of a cover frame is less than or equal to the width the wall protrusion in order to avoid shading the interior. A grommet is installed on each end wall to accommodate micro-watering feed lines. By installing a grommet on both ends, the devices can be daisy chained. The outside of the walls is typically a dark color such as brown or green and the interior of the walls is typically a reflective light color such as white. The outsides of the top protrusions are typically a light color such as white.

### The Apparatus Is Used as Follows

If planting seeds, the soil for the seeds is first prepared. To provide augmented protection from crawling pests, the underside of the top channel can be coated with a sticky insect trap such as Tanglefoot or double sided insect cards. By placing this material on the underside of the channel, it is protected from sun and rain thus extending its effectiveness. The apparatus is placed over the location where the seeds are to be planted with the bottom flared edge buried a short distance into the soil leaving no visible access from the outside. Hold-down spikes are inserted into the bottom flared edge to secure the apparatus from accidental disturbance. The flared edge is then covered with soil a short distance up the side of the apparatus leaving no gaps around the bottom edge. If the optional micro watering capability is to be utilized, it is installed when the apparatus is in place. Before planting seeds, the interior of the apparatus may be treated with an eco-friendly insecticidal material to help eliminate any in situ pests. Once the initial preparations have been completed, planting is carried out according to the instructions appropriate to the particular seeds. The detachable insect cover or transparent cover may be installed as desired.

If planting seedlings, the same process described for planting seeds is followed. If the seedlings protrude above the top of the apparatus, the insect cover would not be installed. If installed, it would be removed before the seedling growth contacts it in order to prevent any damage to the seedlings. Similarly, if the transparent cover is installed, it would be removed before the seedling growth contacts it.

When the apparatus is installed as described above, the bottom flared edge will be a short distance below the soil surface. The lower edge of the channel, however, will not be in contact with the soil surface. The channel will be above the soil such that any crawling pest must traverse the outside of a wall, traverse the lower surface of the outward protrusion, traverse the inside surface of the downward protrusion towards the soil, traverse the sharp edge of the downwards protrusion, traverse the outside surface of the downward protrusion away from the soil surface and traverse the upper surface of the outward protrusion to gain access to the interior of the apparatus. If a sticky insect trap material has been applied to the inside surfaces of the channel, this would be a further obstacle to overcome.

One object of the invention is to provide protection for plant material and, in particular sprouting seeds and seedlings, from pests that damage tender growth. It does this by restricting access for opportunistic crawling pests crawling and/or flying pests. Crawling pests are confronted with the barrier provided by the exterior walls and top channel of the apparatus and by the optional application of a sticky substance under the top channel of the apparatus. Access to plant material by flying pests is prevented by installation of a removable insect cover when the plant material is in the critical early growth stage.

It is a further object of the invention to provide an enhanced environment for plant material growth by increasing the incident sunlight on plant material inside the apparatus and reducing evapotranspiration from the plant material and soil surface.

It is a further object of the invention to provide enhanced micro-climate control during periods of cooler weather or frost by means of a removable transparent cover.

It is a further object of the invention to promote the conservation of water by delivering irrigation in a closed space without runoff.

It is a further object of the invention to help prevent plant diseases caused by wet foliage by using micro-irrigation inside the apparatus.

It is a further object of the invention to provide a contained micro-environment for the administering of eco-friendly pesticides. These materials can be applied inside the apparatus only thus reducing the quantity of material required and the area covered.

### DRAWINGS

### Figures

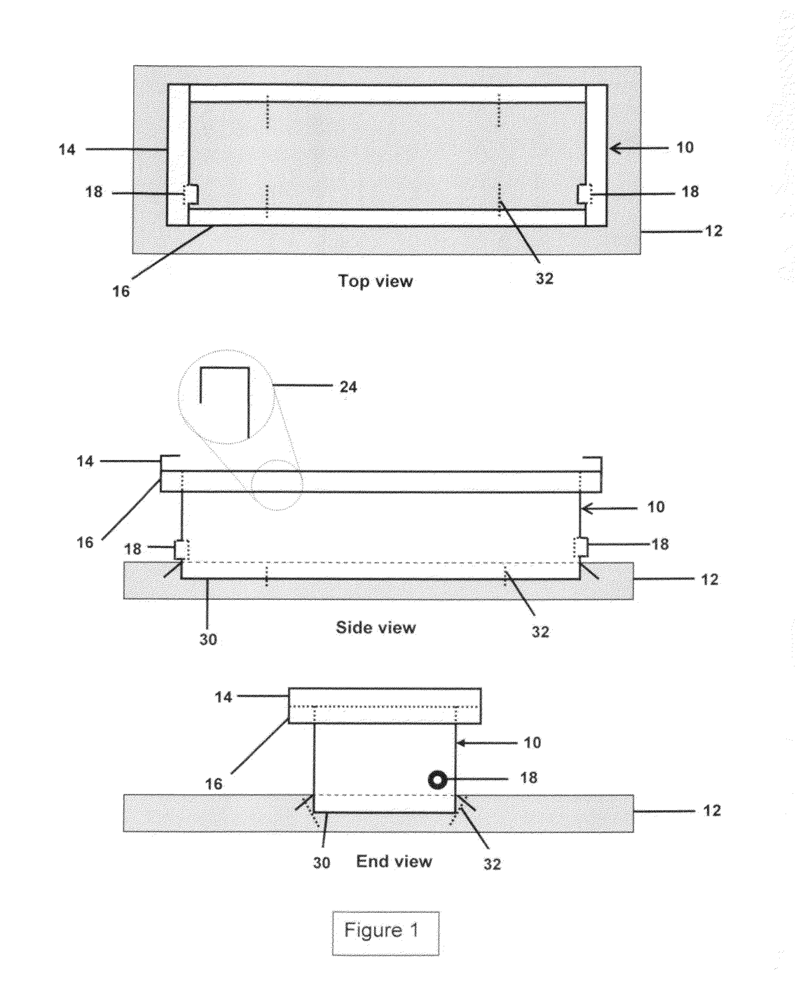

FIG. 1 is the top view, side view and end view of the preferred embodiment of the in situ plant protector. The brackets 14 are optional.

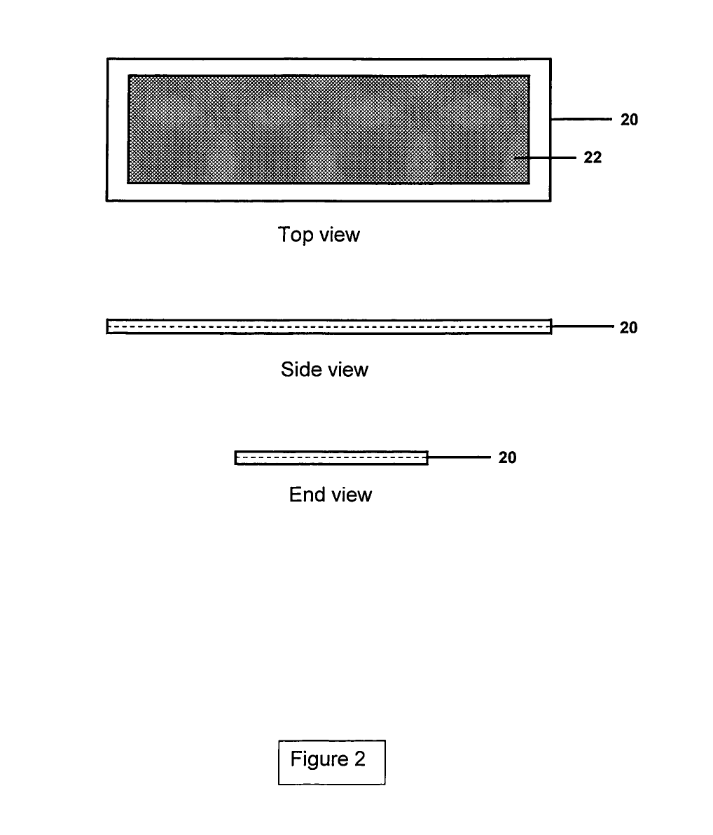

FIG. 2 is the top view, side view and end view of the removable insect cover with insect screening material suitable for installation on the embodiment of the apparatus depicted in FIG. 1.

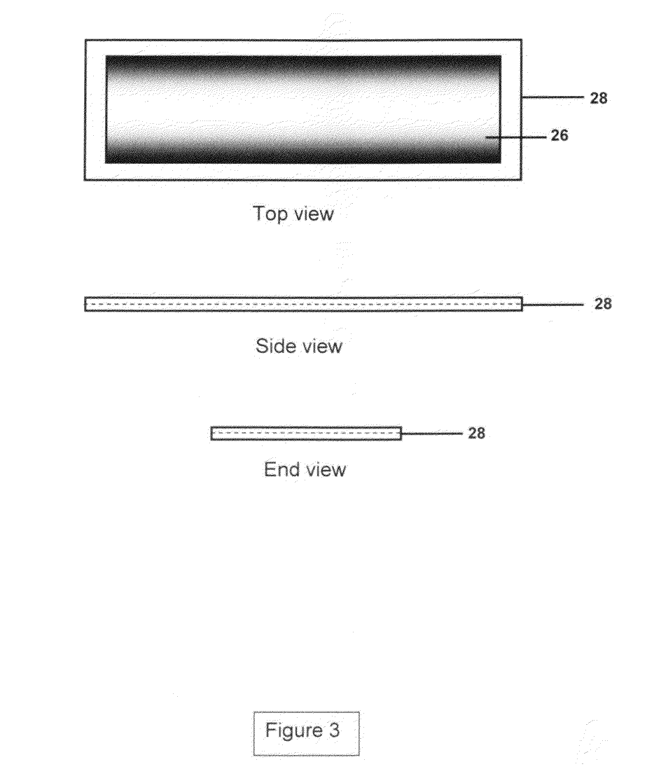

FIG. 3 is the top view, side view and end view of the removable transparent cover with transparent material suitable for installation on the embodiment of the apparatus depicted in FIG. 1.

DRAWINGS - Reference Numerals

| | |
|---|---|
| 10 plant protection apparatus | 12 soil |
| 14 optional brackets | 16 channel |
| 18 grommet | 20 frame |
| 22 insect screening material | 24 cutaway view |
| 26 transparent material | 28 frame |
| 30 walls | 32 spikes |

### DETAILED DESCRIPTION OF THE PREFERRED EMBODIMENT

In FIG. 1, a plant protection apparatus 10 is illustrated in accordance with a preferred embodiment of the invention.

A rectangular enclosure is formed from smooth plastic or metal. The top of the enclosure has a contiguous channel 16 formed around it protruding out from the inside of the enclosure and then downwards. The downwards portion of the channel protrudes less than the height of the enclosure such that, when the apparatus is inserted into the soil, the bottom edge of the downwards protrusion is above the soil level. The channel 16 is continuous with no gaps in the outward or downward protrusions. The cutaway view 24 depicts the channel. Optional brackets 14 are formed on both of the top ends of the enclosure which brackets may be used to hold a removable insect cover illustrated in FIG. 2 or removable transparent cover illustrated in FIG. 3. A grommet 18 with a removable plug is installed on both ends of the plant protector for the purpose of passing a micro-irrigation supply tube into the enclosure. The plug prevents the incursion of insects when the irrigation tube is not installed. A portion of the bottom edges of the walls 30 is bent outwards at an angle less than 90 degrees making the walls more rigid and creating a location wherein hold down spikes 32 may be inserted to hold the apparatus firmly in the soil.

In FIG. 2, a removable insect cover is illustrated in accordance with a preferred embodiment of the invention. The insect cover consists of a rigid metal or plastic frame 20 covered with insect screening material 22. The frame 20 slides into the optional brackets 14 formed on the top ends of the plant protection apparatus 10.

In FIG. 3, a removable transparent cover is illustrated in accordance with a preferred embodiment of the invention. The transparent cover consists of a rigid metal or plastic frame 28 covered with transparent material 26 such as acrylic or plastic. The frame 28 slides into the optional brackets 14 on the top ends of the plant protection apparatus 10.

The plant protection apparatus described above is easily installed into the soil 12 by loosening the soil at the installation site and pressing the frame into the soil. If micro-irrigation is to be used, the plug is removed from the grommet 18 allowing a water feeder tube to be passed into the interior of the plant protector. Seeds, seedlings or plants are then inserted into the soil inside the plant protection apparatus 10. The removable insect cover FIG. 2 or transparent cover FIG. 3 can be installed as required.

For those skilled in the art of plant protection and in light of the foregoing disclosure, many alterations and modifications are possible in the practice of this invention without departing from the spirit and scope thereof. Accordingly, the scope of the invention is to be construed in accordance with the substance defined by the following claims.

We claim:

1. An apparatus for protecting plant material from damage by crawling and flying pests; for administering efficient micro-irrigation with minimal loss of water due to runoff; for enhancing growth of sprouting seeds and seedlings by way of reflected sunlight and better management of humidity and heat in the growing area; for mitigation of foliar diseases by preventing wetting of foliage from irrigation; and for more effective application of eco-friendly pesticides within a contained space comprising:
a box with an open top and bottom which box has small holes in the box walls near the bottom wherein hold down spikes may be inserted; and
a continuous channel extending outwards from the top of the box walls which channel is formed by bending or molding the top of the walls into an L-shaped configuration; and
in or on which channel an optional insect barrier material may be utilized to further restrict access of pests to the interior of the box; and
optional C-shaped brackets mounted on top of two opposing sides of the channel with the open side of the C-shaped brackets facing to the inside of the box and with one side of the C-shaped brackets attached to the channel by adhesive, screws, rivets or other suitable means; and
a removable insect cover which is a frame covered with insect screening material attached to the interior of the frame or a removable transparent cover which is a frame covered with transparent material attached to the interior of the frame; and which removable insect cover or removable transparent cover is affixed to the top of the box by sliding the cover into the C-shaped brackets when they have been affixed to the channel; and
a grommet with a removable plug to provide access to the interior of the box for a micro-watering supply tube which tube shall fit tightly in the hole in the grommet so as to prevent pest incursion at the location of the grommet;

2. The apparatus as defined in claim 1, wherein the box is made from plastic or metal.

3. The apparatus as defined in any one of claims 1 to 2, wherein the top channel is made from plastic or metal.

4. The apparatus as defined in any one of claims 1 to 3, wherein the optional brackets are made from plastic or metal.

5. The apparatus as defined in any one of claims 1 to 4, wherein the frame of the insect cover is made from plastic or metal and the interior of which frame is covered with an insect screening material allowing passage of sunlight.

6. The apparatus as defined in any one of claims 1 to 5, wherein the frame of the transparent cover is made from plastic or metal and the interior of which frame is covered with transparent material allowing passage of sunlight such as sunlight stable clear plastic.

7. The apparatus as defined in any one of claims 1 to 6, wherein the inside of the box and the outside of the channel are a colour that will promote reflection of sunlight onto plant material inside the apparatus.

8. The apparatus as defined in any one of claims 1 to 7, wherein the outside vertical walls and the inside of the channel are a colour that can promote some generation of heat within the box from incident sunlight.

9. The apparatus as defined in any one of claims 1 to 8, wherein the micro-irrigation access grommet is made from plastic or rubber or is molded into the box.

10. The apparatus as defined in any one of claims 1 to 9, wherein hold down spikes are made from plastic or metal.
